(19) United States
(12) Patent Application Publication
(10) Pub. No.: US 2014/0233242 A1
(43) Pub. Date: Aug. 21, 2014

(54) LIGHT SOURCE MODULE AND LIGHTING APPARATUS HAVING THE SAME

(71) Applicant: Samsung Electronics Co., Ltd., Suwon-Si (KR)

(72) Inventors: Won Hoe KOO, Seoul (KR); June JANG, Seoul (KR); Kyeong Ik MIN, Suwon-si (KR)

(73) Assignee: SAMSUNG ELECTRONICS CO., LTD., Suwon-Si (KR)

(21) Appl. No.: 14/023,567

(22) Filed: Sep. 11, 2013

(30) Foreign Application Priority Data
Feb. 21, 2013 (KR) 10-2013-0018551

(51) Int. Cl. F21V 5/04; F21V 13/04

(52) U.S. Cl. CPC F21V 5/046; F21V 13/04
USPC 362/308; 362/311.01

(57) ABSTRACT

A light source module including a light source, a first lens disposed above the light source and including a through hole penetrating through top and bottom surfaces thereof, and a second lens disposed to face the light source within the through hole and moving in an optical axis direction to adjust an amount of light incident to the first lens, the light generated by the light source, may be provided.

### CROSS-REFERENCE TO RELATED APPLICATIONS

This application claims priority under 35 U.S.C. §119 to Korean Patent Application No. 10-2013-0018551, filed on Feb. 21, 2013, in the Korean Intellectual Property Office, the disclosure of which is incorporated herein by reference in its entirety.

### BACKGROUND

1. Field

The present inventive concepts relate to light source modules and/or lighting apparatuses having the same.

2. Description of the Related Art

In existing lighting apparatuses, a reflective plate or a lens may be used as an optical component capable of adjusting light distribution. However, the shape of a reflective plate or a lens is usually fixed to provide a single pattern of light distribution depending on the structure of a product.

Therefore, in order to change the pattern of light distribution according to lighting design, the installed lighting apparatus should be replaced.

### SUMMARY

Some example embodiments of the present inventive concepts provide light source modules capable of adjusting a pattern of light distribution and/or lighting apparatuses having the same that can be used in various applications according to lighting design.

According to one example embodiment, a light source module includes a light source, a first lens disposed above the light source and including a through hole penetrating through top and bottom surfaces thereof, and a second lens facing the light source within the through hole, having an optical axis, and configured to move along the optical axis in the through hole.

The first lens may include a light exit surface defined by the top surface, the top surface being larger than the bottom surface, and a reflective surface defined by a lateral surface between the top and bottom surfaces, and provided around a circumference of the through hole, the reflective surface configured to guide the light from the light source to the light exit surface.

The first lens may further include a plurality of recesses formed in a surface of the through hole in the optical axis direction, and the second lens may include a plurality of protrusions formed on an outer surface thereof such that at least one of the protrusions is selectively inserted into at least one of corresponding recesses.

The first lens may further include a guide groove formed by cutting a portion of an outer surface thereof, the guide groove configured to expose the through hole, and the second lens may include an extension part protruding outwardly of the outer surface of the first lens through the guide groove.

The first lens may further include a support extending from the bottom surface thereof in a radial direction, the first lens configured to attach to the light source.

The second lens may have a pillar structure having a cross-sectional shape corresponding to that of the through hole, and include top and bottom surfaces exposed outwardly through the through hole, a light incident surface defined by the bottom surface and facing the light source.

The light incident surface may include one of a convex surface, a flat surface and a concave surface.

The second lens may include a grip protruding from a top surface thereof.

The first lens may be configured to attach to the light source.

The light source may include a substrate, and at least one light emitting device mounted on the substrate.

According to another example embodiment, a lighting apparatus includes a main body, a light source mounted on one surface of the main body, and a lens unit mounted on the surface of the main body to be disposed above the light source, wherein the lens unit includes a first lens disposed above the light source and including a through hole penetrating through top and bottom surfaces thereof, and a second lens disposed to face the light source within the through hole and moving in an optical axis direction to adjust an amount of light incident to the first lens, the light generated by the light source.

The first lens may be configured to attach to the main body, and the second lens may be configured to move within the through hole to change a distance from the light source and adjust distribution of light externally irradiated through the lens unit.

The second lens may have a pillar structure having a cross-sectional shape corresponding to that of the through hole, and include top and bottom surfaces exposed outwardly through the through hole, a light incident surface defined by the bottom surface, and facing the light source.

The lighting apparatus may further include a housing enclosing a circumference of the lens unit so as to protect the lens unit.

The housing may include an opening configured to expose the lens unit.

According to still another example embodiment, a light source module includes a light source, a first lens on the light source, the first lens including a bottom reflective surface and a top light exit surface, the first lens including a through hole, and a second lens facing the light source, the second lens coupled to the first lens in the through hole, the second lens configured to move in the through hole and along an longitudinal axis of the through hole.

The second lens may include a structure having a cross-sectional shape corresponding to that of the through hole, and includes a bottom surface facing the light source and a top surface exposed outwardly.

The first lens may include a guide groove, the guide groove being an opening defined at one side surface of the first lens such that the through hole is exposed, and the second lens includes an extension part, the extension part configured to adjust the location of the second lens through the guide groove.

The second lens may include a grip portion, the grip portion protruding from a top surface thereof to allow a user to easily grip the second lens.

The first lens may include one of a plurality of recesses and a plurality of protrusions, the second lens includes the other one of a plurality of recesses and a plurality of protrusions, both of the recesses and protrusions are disposed at a regular interval in the longitudinal axis of the through hole, and the first lens and the second lens are configured to be coupled to each other by engaging at least one of the plurality of recesses with a corresponding one of the plurality of protrusions.

An optical axis of the second lens coincides with the longitudinal axis of the through hole.

### BRIEF DESCRIPTION OF THE DRAWINGS

The above and other aspects, features and other advantages of the present inventive concepts will be more clearly understood from the following detailed description taken in conjunction with the accompanying drawings, in which:

FIG. 1 is a schematic perspective view illustrating a light source module according to an example embodiment of the present inventive concepts;

FIGS. 2A and 2B are a schematic cross-sectional view and a schematic plan view illustrating the light source module of FIG. 1, respectively;

FIGS. 3A and 3B are schematic cross-sectional views illustrating modified example embodiments of a first lens in the light source module of FIG. 1;

FIGS. 4A and 4B are schematic cross-sectional views illustrating modified example embodiments of a second lens in the light source module of FIG. 1;

FIGS. 5A and 5B are schematic cross-sectional views illustrating a state in which a location of the second lens is changed in the light source module of FIG. 1;

FIG. 6A is a schematic cross-sectional view illustrating an optical path in the light source module of FIG. 5A;

FIG. 6B is a graph schematically illustrating a light distribution curve;

FIG. 7A is a schematic cross-sectional view illustrating an optical path in the light source module of FIG. 5B;

FIG. 7B is a graph schematically illustrating a light distribution curve;

FIGS. 8A and 8B are views illustrating illuminance distribution of FIGS. 6A and 7A;

FIGS. 9A and 9B are schematic cross-sectional views illustrating modified example embodiments of the first and second lenses of FIG. 1;

FIGS. 10A through 10C are schematic cross-sectional views illustrating modified example embodiments of the first and second lenses of FIGS. 9A and 9B;

FIGS. 11A and 11B are schematic perspective views illustrating other example embodiments of first and second lenses;

FIGS. 12A and 12B are schematic cross-sectional views illustrating the first and second lenses of FIGS. 11A and 11B;

FIGS. 13A and 13B are schematic cross-sectional views illustrating still other example embodiments of the first and second lenses of FIG. 1;

FIG. 14 is a schematic cross-sectional view illustrating a lighting apparatus according to an example embodiment of the present inventive concepts; and

FIGS. 15A and 15B are views schematically illustrating states in which the lighting apparatus of FIG. 14 is used as an indoor lighting apparatus by being suspended from a ceiling of a building.

### DETAILED DESCRIPTION OF THE EMBODIMENTS

Example embodiments of the present inventive concepts will now be described in detail with reference to the accompanying drawings.

The present inventive concepts may be exemplified in many different forms and should not be construed as being limited to the specific embodiments set forth herein. Rather, these example embodiments are provided so that this disclosure will be thorough and complete, and will fully convey the scope of the inventive concepts to those skilled in the art.

In the drawings, the shapes and dimensions of elements may be exaggerated for clarity, and the same reference numerals will be used throughout to designate the same or like elements.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element (s) or feature (s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of example embodiments. It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

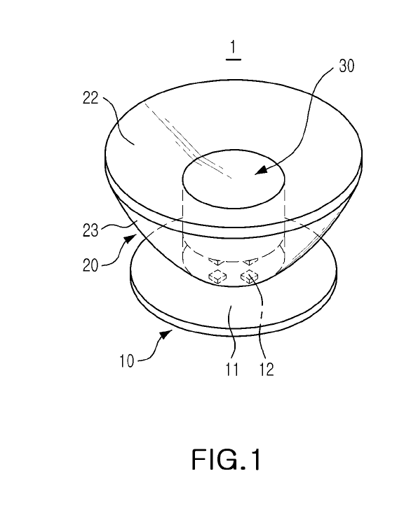

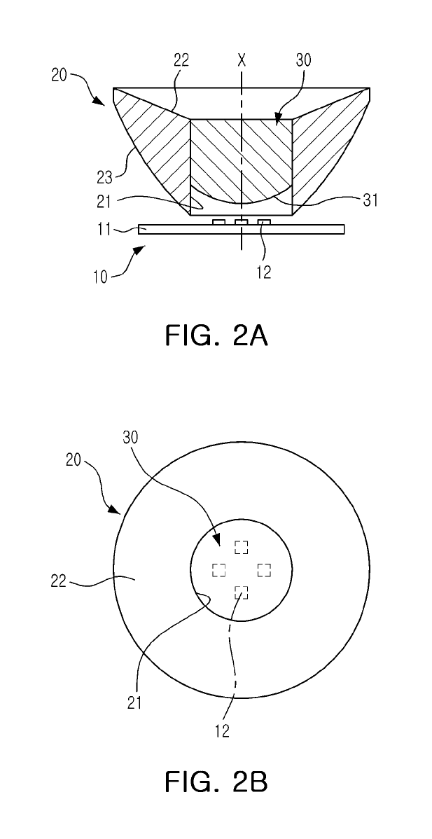

A light source module according to an example embodiment of the present inventive concepts will be described with reference to FIGS. 1, 2A and 2B. FIG. 1 is a schematic perspective view illustrating a light source module according to an example embodiment of the present inventive concepts, and FIGS. 2A and 2B are a schematic cross-sectional view and a schematic plan view illustrating the light source module of FIG. 1, respectively.

With reference to FIGS. 1, 2A and 2B, a light source module 1 according to the embodiment of the present inventive concepts may include a light source 10, a first lens 20, and a second lens 30 disposed within the first lens 20.

The light source 10 may include a substrate 11 and at least one light emitting device 12 disposed on the substrate 11.

The substrate 11 may be a general FR4-type printed circuit board (PCB). The substrate 11 may be formed of an organic resin material containing (e.g., epoxy, triazine, silicon, polyimide, etc.), other organic resin materials, a ceramic material (e.g., silicon nitride, aluminum nitride (AlN), Al₂O₃, etc.), or metal and a metal compound. The substrate 11 may include, for instance, a metal core printed circuit board (MCPCB).

A single light emitting device 12 or a plurality of light emitting devices 12 may be mounted on the substrate 11. The light emitting device 12 may be a type of semiconductor light emitting device producing light having a predetermined or desired wavelength when external power is applied thereto. The light emitting device 12 may include a light emitting diode (LED). The light emitting device 12 may emit blue light, green light or red light according to a material contained therein, and may also emit white light.

The light emitting device 12 in the present example embodiment may be exemplified as a packaging product having LED chips contained therein, but is not limited thereto. For example, the light emitting device 12 may be an LED chip itself. In this case, the LED chip may be mounted on the substrate 11 in a chip on board (COB) manner and may be directly electrically connected to the substrate 11 using a flip chip bonding method or a wire bonding method.

The plurality of light emitting devices 12 may be arranged on the substrate 11. For example, the plurality of light emitting devices 12 may be homogeneous devices producing light having the same wavelength. For example, the plurality of light emitting devices 12 may be heterogeneous devices producing light having different wavelengths.

The first lens 20 may be disposed above the light source 10 and allow incident light received from the light source 10, which is disposed downwardly of the first lens 20, to be emitted upwardly. As shown in FIGS. 1, 2A and 2B, the first lens 20 may have a through hole 21 formed in the center thereof, the through hole 21 penetrating bottom and top surfaces of the first lens 20. A diameter area of the through hole 21 may correspond to an area of the light source 10 in which the light emitting devices 12 are arranged, and may have a pillar structure in parallel with an optical axis (X). The optical axis (X) refers to a line along which there is some degree of rotational symmetry in the light source module.

The bottom surface of the first lens 20 may define one opening region of the through hole 21, and the top surface of the first lens 20, larger than the bottom surface thereof, may define a light exit surface 22 together with the other opening region, e.g., a top opening region, of the through hole 21.

The light exit surface 22 may have a downwardly inclined surface in a direction toward the central through hole 21. The inclined light exit surface 22 may realize focused light distribution and the pattern of focused light distribution may be changed according to an angle of inclination of the light exit surface 22.

The first lens 20 may have a reflective surface 23 defined by a lateral surface between the top and bottom surfaces thereof. The reflective surface 23 may be provided around a circumference of the through hole 21 to enclose the through hole 21, and may be connected to one end of the through hole 21 adjacent to the light source 10 corresponding to the bottom surface of the first lens 10. Therefore, the first lens 20 may have a cup-shaped structure expanded upwardly.

The reflective surface 23 may guide the light from the light source 10 to the light exit surface 22, and the light exit surface 22 may release the guided light externally.

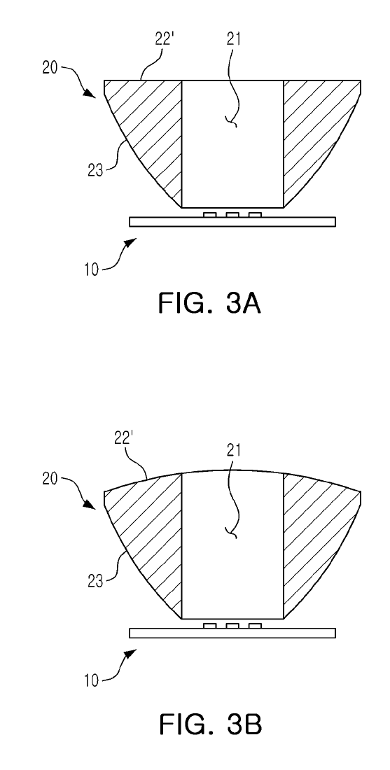

In the present example embodiment, the light exit surface 22 of the first lens 20 may be inclined in a direction toward the center thereof, but is not limited thereto. FIGS. 3A and 3B illustrate modified examples of the first lens 20.

As shown in FIG. 3A, a top surface of the first lens 20, e.g., a light exit surface 22′ thereof may be formed as a flat surface. As shown in FIG. 3B, the light exit surface 22′ of the first lens 20 may be formed as an upwardly convex surface. The shapes of the light exit surfaces 22 or 22′ may change according to lighting design.

The terms ‘upper portion,’ ‘lower portion,’ ‘top surface,’ ‘bottom surface,’ and the like used in the disclosure are based on the accompanying drawings, and they may be changed according to an actual arrangement of a lens unit.

The second lens 30 may be provided to be separated from the first lens 20 and to be disposed to face the light source 10 within the through hole 21. The second lens 30 may move vertically in an optical axis direction X within the through hole 21, or alternatively move along a longitudinal axis of the through hole 21. The optical axis direction may coincide with the longitudinal axis of the through hole 21.

The second lens 30 may have a pillar structure having a cross-sectional shape corresponding to that of the through hole 21. In the present example embodiment, the second lens 30 is illustrated as having a cylindrical structure as shown in FIGS. 1 and 2, but is not limited thereto. For example, the cross-sectional shape of the second lens 30 may be quadrangular, pentagonal, hexagonal, octahedral, etc.

End surfaces of the second lens 30, e.g., top and bottom surfaces thereof may be externally exposed through the through hole 21. The second lens 30 may have a light incident surface 31 defined by the bottom surface thereof and facing the light source 10.

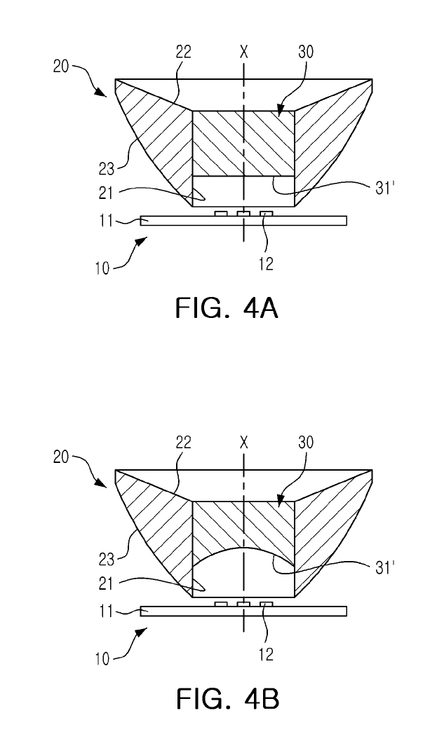

The light incident surface 31 may have a convex surface in a direction toward the light source 10. Alternatively, a light incident surface 31′ may be a flat surface as shown in FIG. 4A, or may be a concave surface as shown in FIG. 4B. The structure of the light incident surface 31 may be selectively employed according to lighting design to be implemented.

In the present example embodiment, the top surface of the second lens 30 opposite to the light incident surface 31 thereof may be a flat surface, but is not limited thereto. For example, the top surface of the second lens 30 may be an upwardly convex surface or downwardly concave surface.

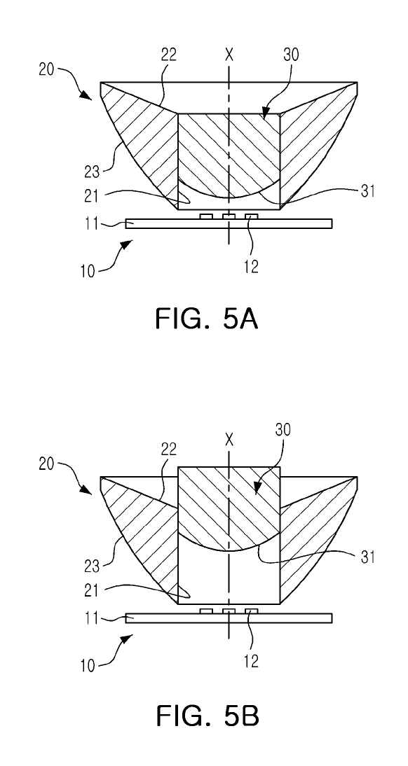

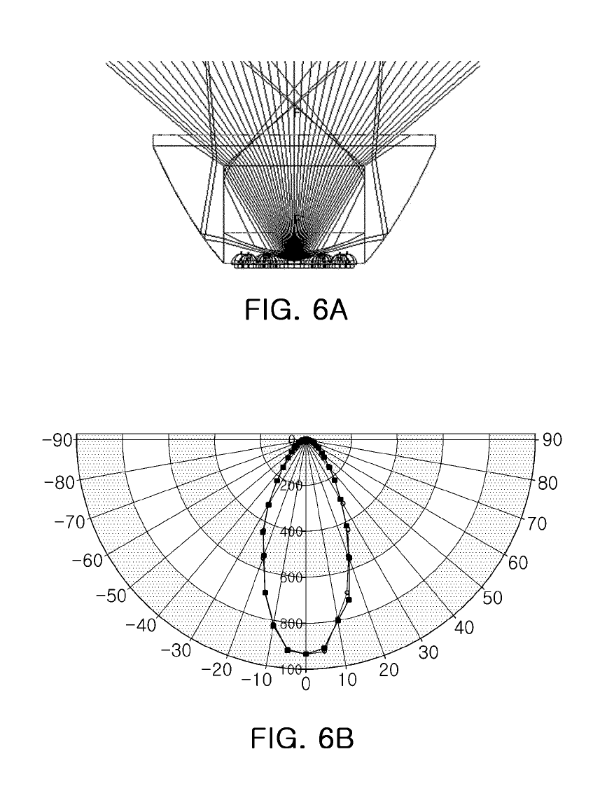

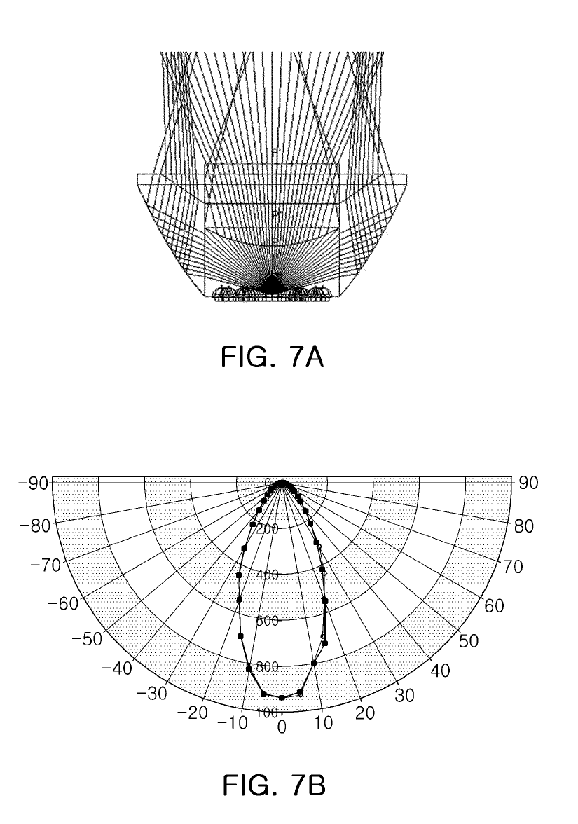

As shown in FIGS. 5A and 5B, the second lens 30 may move vertically in the optical axis direction X within the through hole 21 of the first lens 20 or alternatively move along the longitudinal axis of the through hole 21. An amount of light incident to the first lens 20 may be adjusted through the vertical movement of the second lens 30 such that the pattern of light distribution may be variably changed. This will be described with reference to FIGS. 6A through 7B.

FIG. 6A is a schematic cross-sectional view illustrating an optical path in the light source module of FIG. 5A, and FIG. 6B is a graph schematically illustrating a light distribution curve. FIG. 7A is a schematic cross-sectional view illustrating an optical path in the light source module of FIG. 5B, and FIG. 7B is a graph schematically illustrating a light distribution curve.

As shown in FIGS. 5A and 6A, in a case in which the second lens 30 is disposed to be adjacent to the light source 10, light generated by the light source 10 may be mostly incident to the inside of the second lens 30 through a light incident surface 31 of the second lens 30, and a relatively small amount of light may be incident to the first lens 20.

Most of the light incident to the second lens 30 may be externally irradiated from the light exit surface 22 at a wide angle of irradiation. The light distribution curve of the second lens 30 is illustrated in FIG. 6B.

Meanwhile, as shown in FIGS. 5B and 7A, in a case in which the second lens 30 is disposed to be distant from the light source 10, light generated by the light source 10 may be incident to the second lens 30 and the first lens 20, and an amount of light incident to the first lens 20 may be increased as compared with the case of FIG. 6A.

A change in the location of the second lens 30 due to the movement of the second lens 30 may cause a focal point of the second lens 30 from the light source 10 to be changed, and thus a certain amount of the light incident to the second lens 30 may be externally irradiated at a relatively narrow angle of irradiation, as compared with the case of FIG. 6A. The remainder of light incident to the first lens 20 may be reflected by the reflective surface 23 and may be externally irradiated through the light exit surface 22. Accordingly, the light may be irradiated at a narrow angle of irradiation, thereby realizing focused light distribution. The light distribution curve of the second lens of this case is illustrated in FIG. 7B.

As shown in FIGS. 6A and 7A, different patterns of light distribution may be obtained according to changes in the location of the second lens 30. Various patterns of light distribution, rather than a single fixed pattern of light distribution, may be obtained by adjusting the location of the second lens 30.

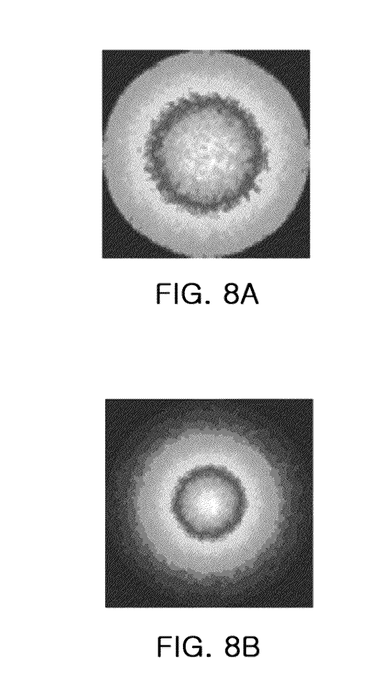

FIGS. 8A and 8B are views illustrating illuminance distribution of FIGS. 6A and 7A. It could be appreciated that the illuminance distribution may change according to a difference in the pattern of light distribution.

The first lens 20 and the second lens 30 may be formed of a resin material having light transmissive properties. For example, polycarbonate, polymethyl methacrylate (PMMA), or the like may be used therefor. The first lens 20 and the second lens 30 may also be formed of a glass material. The material of the first lens 20 and the second lens 30 is not limited thereto.

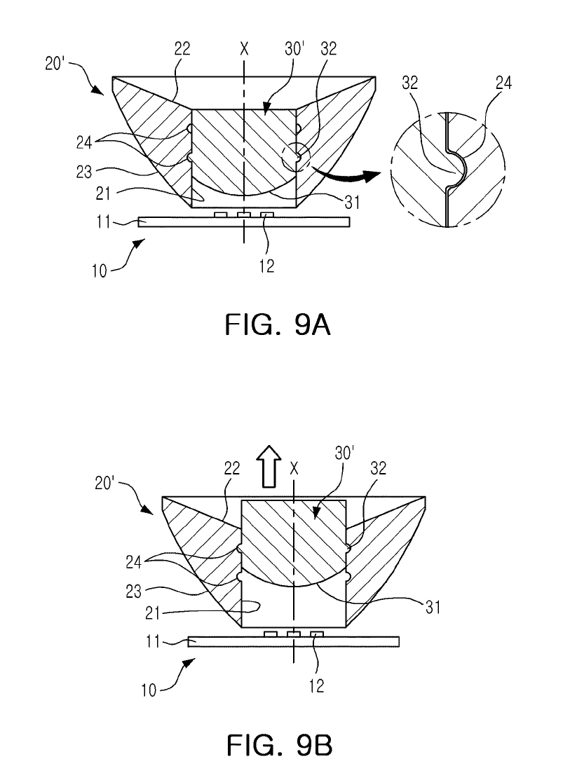

FIGS. 9A and 9B are schematic cross-sectional views illustrating modified example embodiments of the first and second lenses of FIG. 1. Structures of first and second lenses 20′ and 30′ in the present example embodiments illustrated in FIGS. 9A and 9B may be substantially the same as those of the first and second lenses in the above-described example embodiments illustrated in FIGS. 1 through 5B, except that the first and second lenses 20′ and 30′ may be provided with recesses 24 and protrusions 32 disposed therebetween. Hereinafter, overlapping descriptions between the present example embodiment and the above-described embodiments will be omitted and the modified structure of the first and second lenses 20′ and 30′ will mainly be described.

As shown in FIGS. 9A and 9B, the first lens 20′ may include the plurality of recesses 24 formed on a surface of the through hole 21 in the optical axis direction X or alternatively along the longitudinal axis of the through hole 21. The plurality of recesses 24 may adjust the location of the second lens 30′ moving within the through hole 21, and may be spaced apart from one another by a regular interval in the optical axis direction X or alternatively along the longitudinal axis of the through hole 21. The locations of the plurality of recesses 24 may define the location of the second lens 30′.

In the present example embodiment, two recesses 24 may be disposed vertically, but the number of recesses is not limited thereto. Three or more recesses may be provided so that the location of the second lens 30′ may be finely adjusted according to intervals between the recesses.

The second lens 30′ may include the protrusion 32 formed on an outer surface thereof such that the protrusion 32 may be selectively inserted into any one of the plurality of recesses 24. The protrusion 32 may be inserted into any one of the plurality of recesses 24 while the second lens 30′ moves vertically within the through hole 21 in the optical axis direction X or alternatively moves along the longitudinal axis of the through hole 21, so that the second lens 30′ may be appropriately disposed in a location set within the through hole 21.

In the present example embodiment, the location of the second lens 30′ may be adjusted through the recesses 24 formed in the through hole 21 of the first lens 20′ and the protrusion 32 formed on the second lens 30′. The second lens 30′ may move within a limited range defined by the intervals between the recesses 24.

Meanwhile, in the present example embodiment, the recess 24 and the protrusion 32 may be engaged with one another, but are not limited thereto. For example, the surface of the through hole 21 of the first lens 20′ and the surface of the second lens 30′ may be provided with a screw thread. Accordingly, the first lens 20′ and the second lens 30′ may be coupled to one another by a screw coupling method.

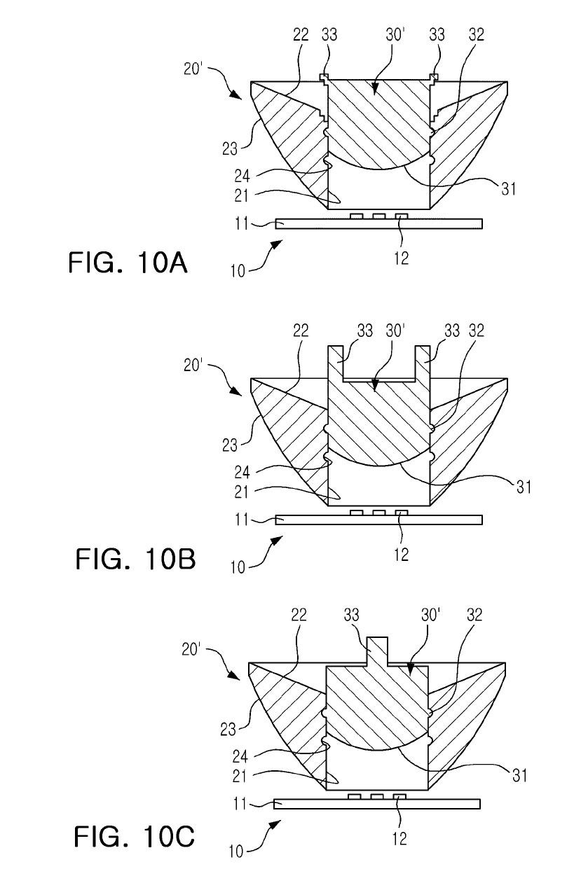

FIGS. 10A through 10C are schematic cross-sectional views illustrating modified example embodiments of the first and second lenses of FIGS. 9A and 9B. A structure of the first and second lenses 20′ and 30′ in the present example embodiment illustrated in FIGS. 10A through 10C may be substantially the same as that of the first and second lenses in the above-described embodiment illustrated in FIGS. 9A and 9B, except that the second lens 30′ is provided with a grip 33.

As shown in FIGS. 10A through 10C, the second lens 30′ may include the grip 33 protruded from a top surface thereof.

The grip 33 may allow for a user to directly grip the second lens 30′ to thereby adjust the location of the second lens 30′. To enable this, the grip 33 may be protruded from the top surface of the second lens 30′, thereby allowing a user to easily grip the second lens 30′.

As shown in FIG. 10A, the grip 33 may be stepped on an edge of the top surface of the second lens 30′. Alternatively, as shown in FIG. 10B, the grip 33 may be protruded from the edge of the top surface of the second lens 30′. Alternatively, as shown in FIG. 10C, the grip 33 may be protruded from the center of the top surface of the second lens 30′.

In the present example embodiment, the first and second lenses 20′ and 30′ may be provided with the recesses 24 and the protrusion 32, respectively, but the structure of the first and second lenses 20′ and 30′ is not limited thereto. For example, like the first and second lenses 20 and 30 of FIGS. 1 through 5B, the recesses 24 and the protrusion 32 may be omitted.

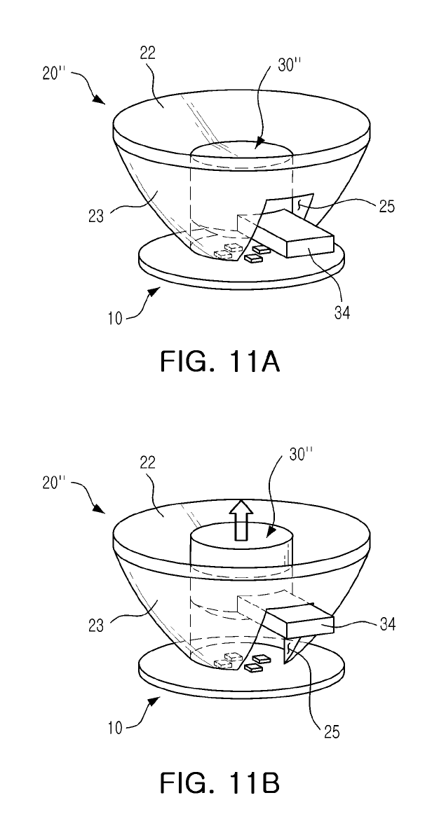

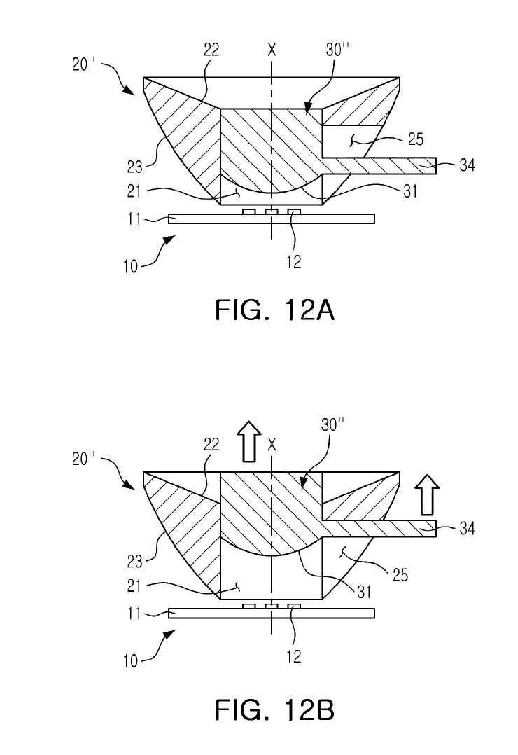

FIGS. 11A through 12B are schematic views illustrating other example embodiments of the first and second lenses. Structures of first and second lenses 20″ and 30″ in the present embodiment illustrated in FIGS. 11A through 12B may be substantially the same as those of the first and second lenses in the above-described embodiments illustrated in FIGS. 1 through 10C, except that the first and second lenses 20″ and 30″ are provided with a guide groove 25 and an extension part 34, respectively. Hereinafter, overlapping descriptions between the present example embodiment and the above-described example embodiments will be omitted and the modified structure of the first and second lenses 20″ and 30″ will mainly be described.

As shown in FIGS. 11A through 12B, the first lens 20″ may include the guide groove 25 formed by cutting a portion of an outer surface thereof to allow a portion of the through hole 21 to be exposed outwardly. Specifically, the guide groove 25 may be formed by partially cutting a portion of the reflective surface 23 of the first lens 20″ in the optical axis direction X or alternatively along the longitudinal axis of the through hole 21, and the cutting process may be performed to allow the guide groove 25 to be extended from the through hole 21, the cut portion having a constant thickness. The through hole 21 may be partially exposed outwardly of the reflective surface 23 of the first lens 20″ through the guide groove 25.

The second lens 30″ may include the extension part 34 protruded outwardly of the outer surface of the first lens 20″ through the guide groove 25. The extension part 34 may be protruded outwardly from the outer surface of the second lens 30″ to penetrate through the guide groove 25. The extension part 34 may be integrated with the second lens 30″. In addition, the extension part 34 may be attached to the outer surface of the second lens 30″ using an adhesive, etc. In this case, the extension part 34 may be formed of the same material as that of the second lens 30″.

The extension part 34 together with the guide groove 25 may serve to finely adjust the location of the second lens 30″. For example, the extension part 34 may move vertically along the guide groove 25 by external force applied thereto. Accordingly, the location of the second lens 30″ may be adjusted while moving within the through hole 21. For example, the extension part 34 may be moved by a user. A user may directly move the extension part 34 such that the location of the second lens 30″ is adjusted. Alternatively, the extension part 34 may be connected to a driving unit, e.g., an actuator, such that the location of the second lens 30″ may be automatically adjusted. In this case, the operation of the actuator may be controlled by a remote control unit.

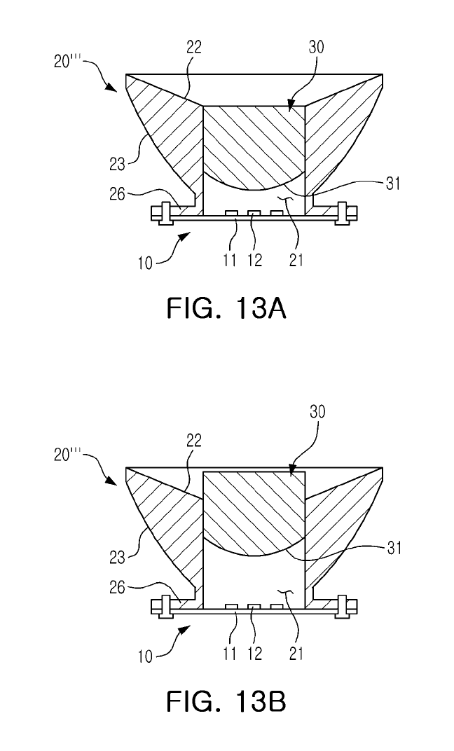

FIGS. 13A and 13B are schematic cross-sectional views illustrating other example embodiments of the first and second lenses. Structures of first and second lenses 20″′ and 30 in the present example embodiment illustrated in FIGS. 13A and 13B may be substantially the same as those of the first and second lenses in the above-described example embodiments illustrated in FIGS. 1 through 12B, except that the first lens 20″′ is provided with a support 26. Hereinafter, overlapping descriptions between the present example embodiment and the above-described example embodiments will be omitted and the modified structure of the first and second lenses 20″′ and 30 will mainly be described.

As shown in FIGS. 13A and 13B, the first lens 20″′ may include the support 26. The support 26 may be extended from a bottom surface thereof in a radial direction to be integrated with the first lens 20″′. The support 26 may be attached to the substrate 11 of the light source 10, so that the first lens 20″′ may be directly attached to the light source 10.

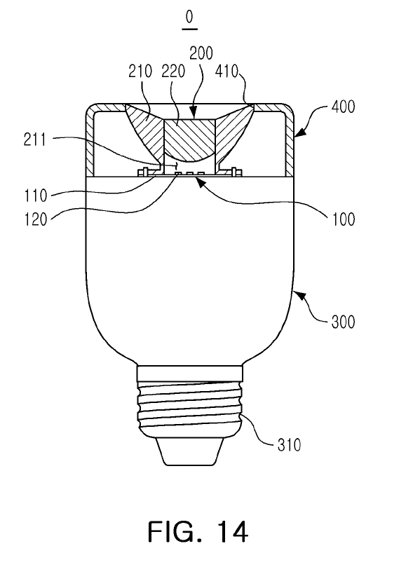

A lighting apparatus according to an example embodiment of the present inventive concepts will be described with reference to FIG. 14. FIG. 14 is a schematic cross-sectional view illustrating a lighting apparatus according to an example embodiment of the present inventive concepts.

With reference to FIG. 14, alighting apparatus 0 according to an example embodiment of the present inventive concepts may include a main body 300, a light source 100 mounted on one surface of the main body 300, and a lens unit 200 mounted on the surface of the main body 300 so as to be disposed above the light source 100. The lighting apparatus 0 may further include a housing 400 enclosing the circumference of the lens unit 200 so as to protect the lens unit 200.

The main body 300 may serve as a basic frame supporting and fixing the light source 100 and the lens unit 200 and as a heat sink dissipating heat generated by the light source 100 outwardly. The main body 300 may be formed of a material having high thermal conductivity and high intensity. For example, the main body 300 may be formed of a metallic material, but the material of the main body 300 is not limited thereto.

A power supply unit (PSU) or the like may be mounted inside the main body 300 so as to supply power to the light source 100. For example, a heat radiating fin may be included in the main body 300 so as to improve heat dissipation efficiency.

A terminal unit 310 may be provided on the other surface of the main body 300 and be electrically connected to a socket when coupled. In the present example embodiment, the terminal unit 310 may be exemplified as an Edison type unit having a screw shape, but is not limited thereto.

The light source 100 may include a substrate 110 and at least one light emitting device 120 mounted on the substrate 110. Because the light source 100 is substantially the same as the light source 10 included in the light source module of FIG. 1, a detailed description thereof will be omitted.

The lens unit 200 may include a first lens 210 and a second lens 220 disposed within the first lens 210.

The first lens 210 may be disposed above the light source 100, and may include a through hole 211 penetrating through top and bottom surfaces thereof. The second lens 220 may be disposed to face the light source 100 within the through hole 211. The second lens 30 may move vertically in an optical axis direction X or alternatively along the longitudinal axis of the through hole 21 such that an amount of light, incident to the first lens 210, of light generated by the light source 100, may be adjusted.

Because the lens unit 200 including the first and second lenses 210 and 220 is substantially the same as the lenses 20 and 30 of the light source module illustrated in FIGS. 1 through 13B, a detailed description thereof will be omitted.

The housing 400 may be mounted on the surface of the main body 300 and be provided to enclose the circumference of the lens unit 200 so as to protect the lens unit 200.

As shown in FIG. 14, the first lens 210 of the lens unit 200 may be directly attached to the substrate 110 of the light source 100 and a light exit surface of the first lens 210 may be exposed outwardly through an opening 410 formed in the center of the housing 400. In the present example embodiment, the first lens 210 of the lens unit 200 may be directly adhered to the substrate 110, but is not limited thereto. For example, the first lens 210 may be adhered to by being press-fitted to the opening 410 of the housing 400.

The housing 400 may be formed of a transparent material or an opaque material. For example, the housing 400 may be formed by injection molding a resin material. For example, the housing 400 may be formed of a metallic material in consideration of heat dissipation or may also be formed of a ceramic material.

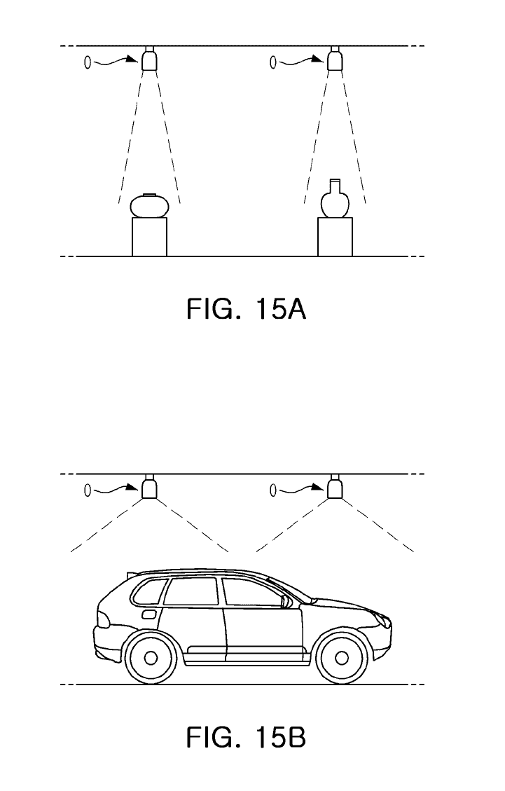

FIGS. 15A and 15B are views schematically illustrating states in which the lighting apparatus of FIG. 14 are used as an indoor lighting apparatus by being suspended from a ceiling of a building.

The lighting apparatus 0 may be used as a down light and the pattern of light distribution thereof may be adjusted by the lens unit 200 configured of the first and second lenses 210 and 220, such that desired lighting design may be implemented according to situation.

For example, in a case in which lighting is required to be focused to illuminate a specific region, the location of the second lens 220 may be adjusted as shown in FIG. 15A to implement a relatively narrow degree of light distribution. The narrow degree of light distribution may be implemented by allowing the second lens 220 to be moved away from the light source 100 as shown in FIG. 5B.

In a case in which lighting is required to illuminate a whole wide region, the location of the second lens 220 may be adjusted in an opposite manner as shown in FIG. 15B to implement a relatively wide degree of light distribution. The wide degree of light distribution may be implemented by allowing the second lens 220 to be moved closely toward the light source 100 as shown in FIG. 5A.

The location of the second lens 220 may be easily adjusted. For example, a user may directly grip the second lens 220 and finely adjust the location of the second lens 220. Alternatively, a user may remotely control an actuator or the like connected to the second lens 220.

In the present example embodiment, the lighting apparatus is exemplified as an indoor lighting apparatus, but is not limited thereto. For example, the lighting apparatus may be used as an outdoor lighting apparatus or used in vehicles, e.g., cars, etc.

As described above, the lighting apparatus according to the present example embodiment may implement various lighting designs by controlling the pattern of light distribution through the adjustment of the location of the lens. Therefore, there is no need to replace the installed lighting apparatus with a lighting apparatus having a desired pattern of light distribution in order to implement lighting design appropriate for situation.

In this disclosure, a double lens structure in which a lens disposed within a fixed lens may be moved without the movement of the entirety of the lens unit. Thus light distribution may be more easily and finely adjusted. Further, a separate unit for moving the entirety of the lens unit may not be necessary. Thus, the miniaturization of a product may be facilitated.

As set forth above, according to example embodiments of the inventive concepts, light source modules capable of adjusting a pattern of light distribution and/or a lighting apparatuses having the same can be used in various applications according to lighting design.

While the present inventive concepts have been shown and described in connection with the example embodiments, it will be apparent to those skilled in the art that modifications and variations can be made without departing from the spirit and scope of the inventive concepts as defined by the appended claims.

What is claimed is:

1. A light source module comprising:
a light source;
a first lens on the light source, the first lens including a through hole penetrating through top and bottom surfaces thereof; and
a second lens facing the light source within the through hole, the second lens having an optical axis and configured to move along the optical axisin the through hole.

2. The light source module of claim 1, wherein the first lens includes:
a light exit surface defined by the top surface, the top surface being larger than the bottom surface; and
a reflective surface defined by a lateral surface between the top and bottom surfaces and around a circumference of the through hole, the reflective surface configured to guide the light from the light source to the light exit surface.

3. The light source module of claim 1, wherein the first lens further includes a plurality of recesses formed at a surface of the through hole in the optical axis direction, and
the second lens includes a plurality of protrusions at an outer surface thereof such that at least one of the protrusions is selectively inserted into at least one of corresponding recesses.

4. The light source module of claim 1, wherein the first lens further includes a guide groove, the guide groove being a cut-out portion at an outer surface of the first lens, the guide groove configured to expose the through hole, and
the second lens includes an extension part protruding outwardly of the outer surface of the first lens through the guide groove.

5. The light source module of claim 1, wherein the first lens further includes a support extending from the bottom surface thereof in a radial direction, the first lens configured to attach to the light source.

6. The light source module of claim 1, wherein the second lens has a pillar structure having a cross-sectional shape corresponding to that of the through hole, and includes top and bottom surfaces exposed outwardly through the through hole, a light incident surface defined by the bottom surface and facing the light source.

7. The light source module of claim 6, wherein the light incident surface includes one of a convex surface, a flat surface, and a concave surface.

8. The light source module of claim 1, wherein the second lens includes a grip protruding from a top surface thereof.

9. The light source module of claim 1, wherein the first lens is configured to attach to the light source.

10. The light source module of claim 1, wherein the light source includes:
a substrate; and
at least one light emitting device on the substrate.

11. A lighting apparatus comprising:
a main body;
a light source on the main body; and
a lens unit on the surface of the main body and above the light source,
wherein the lens unit includes,
a first lens on the light source, the first lens including a through hole penetrating through top and bottom surfaces thereof; and
a second lens facing the light source within the through hole, the second lens configured to move in an optical axis direction.

12. The lighting apparatus of claim 11, wherein the first lens is configured to attach to the main body, and
the second lens is configured to move within the through hole.

13. The lighting apparatus of claim 11, wherein the second lens has a pillar structure having a cross-sectional shape corresponding to that of the through hole, and includes top and bottom surfaces exposed outwardly through the through hole, a light incident surface defined by the bottom surface, and facing the light source.

14. The lighting apparatus of claim 11, further comprising:
a housing enclosing a circumference of the lens unit.

15. The lighting apparatus of claim 14, wherein the housing includes an opening, the opening configured to expose the lens unit.

16. A light source module comprising:
a light source;
a first lens on the light source, the first lens including a bottom reflective surface and a top light exit surface, the first lens including a through hole; and
a second lens facing the light source, the second lens coupled to the first lens in the through hole, the second lens configured to move in the through hole along a longitudinal axis of the through hole

17. The light source module of claim 16, wherein the second lens has a structure having a cross-sectional shape corresponding to that of the through hole, and includes a bottom surface facing the light source and a top surface exposed outwardly.

18. The light source module of claim 16, wherein
the first lens includes a guide groove, the guide groove being an opening defined at one side surface of the first lens such that the through hole is exposed, and
the second lens includes an extension part, the extension part configured to adjust the location of the second lens through the guide groove.

19. The light source module of claim 16, wherein the second lens includes a grip portion, the grip portion protruding from a top surface thereof to allow a user to easily grip the second lens.

20. The light source module of claim 16, wherein
the first lens includes one of a plurality of recesses and a plurality of protrusions,
the second lens includes the other one of a plurality of recesses and a plurality of protrusions,
both of the recesses and protrusions are disposed at a regular interval in the longitudinal axis of the through hole, and
the first lens and the second lens are configured to be coupled to each other by engaging at least one of the plurality of recesses with a corresponding one of the plurality of protrusions.
